(19) United States
(12) Patent Application Publication
(10) Pub. No.: US 2026/0170477 A1
(43) Pub. Date: Jun. 18, 2026

(54) SELF-SERVICE CHECKOUT APPARATUS AND METHOD

(71) Applicant: Toshiba Tec Kabushiki Kaisha, Tokyo (JP)

(72) Inventor: Toshiki IWAI, Sunto Shizuoka (JP)

(21) Appl. No.: 19/313,268

(22) Filed: Aug. 28, 2025

(30) Foreign Application Priority Data
Dec. 18, 2024 (JP) 2024-221703

(51) Int. Cl. G06Q 20/20; G06Q 20/18; G06Q 20/40

(52) U.S. Cl. CPC G06Q 20/208; G06Q 20/18; G06Q 20/4016

(57) ABSTRACT

According to one embodiment, a self-service checkout apparatus includes a product scanner in a main body. A product placement area is on one side of the main body and a bagging area is on the other. A camera images operations at the apparatus. A control section registers merchandise items in a sales transaction based on commodity codes read by the product scanner, detects a customer’s registration movements based on camera images, identifies a fraud act when a registration movement is detected but no merchandise item corresponding to the registration movement is registered in the sales transaction, and outputs a notification of the fraud act only if at least one merchandise item has already been registered in the sales transaction when the fraud act is identified.

### CROSS-REFERENCE TO RELATED APPLICATION

This application is based upon and claims the benefit of priority from Japanese Patent Application No. 2024-221703, filed December 18, 2024, the entire contents of which are incorporated herein by reference.

### FIELD

Embodiments described herein relate generally to a self-service checkout apparatus and a method.

### BACKGROUND

In related art, in a store such as a supermarket or a convenience store, a full-self-service-type checkout apparatus at which a customer performs both a merchandise registration operation and a payment operation has been adopted. In such a self-service checkout apparatus, the customer places merchandise items (or a basket holding merchandise items) on a placement table. Then, the customer takes merchandise items from the placement table or the basket individually to perform a scanning operation using a scanner or the like to read code symbols attached to the merchandise items being registered. The self-service checkout apparatus identifies the merchandise items being registered by analyzing the code symbols read in the scanning operation and then performs merchandise registration processing of the identified merchandise items. Then, the customer performs a bagging operation of putting the scanned/registered items in a bag set on an bagging table. These actions of taking the merchandise items, scanning the merchandise items, and then bagging the merchandise items can be collectively referred to as a registration operation. In general, a customer performs a registration operation for all merchandise items being purchased, and then performs a payment operation.

At the self-service checkout apparatus, since the customer performs the registration processing by himself or herself, a function of checking whether the customer does anything fraudulent or improper is provided. For example, the self-service checkout apparatus checks a video or an image captured by a camera placed above the checkout apparatus to determine whether actions mimicking the movements of a registration operation were performed without a code symbol being read (that is, actual merchandise registration processing was not performed) to identify a fraud action. If fraud is detected, the self-service checkout apparatus delivers a message indicating fraud has been detected.

It is also the case that some customers bring their own containers, such as reuseable shopping bags, for carrying away purchased merchandise items. Many customers place these containers in the upper most parts of shopping baskets before the start of registration operations. That is, the customer often first performs an action of taking out a container from the basket and setting (attaching) the container on an attachment unit of the bagging table, and then begins registration operations on the merchandise items to be purchased. Alternatively, the customer takes out a container from a pocket and then sets the container on the bagging table (or an attachment unit thereof), and then starts registration operations of the merchandise items to be purchased. The action of setting the container on the bagging table (attachment unit) may be detected as a merchandise item bagging operation, and thus potentially (mis)identified and reported as a fraudulent action by the customer.

### BRIEF DESCRIPTION OF THE DRAWINGS

FIG. 1 is a perspective view of a self-service checkout apparatus according to an embodiment.

FIG. 2 is a block diagram showing a hardware configuration of a self-service checkout apparatus according to an embodiment.

FIG. 3 is a diagram for an explanation of detection of a registration operation by an operation detection unit.

FIG. 4 is a block diagram showing a functional configuration of a self-service checkout apparatus according to an embodiment.

FIG. 5 is a flowchart of control processing of a self-service checkout apparatus according to an embodiment.

FIG. 6 is a flowchart of control processing of a first modified example.

FIG. 7 is a block diagram showing functional aspects of a second modified example.

FIG. 8 is a flowchart of control processing of a second modified example.

### DETAILED DESCRIPTION

An object of the present disclosure is to provide a self-service checkout apparatus and a method that can prevent a mistaken reports of fraud in a self-service checkout system or the like. Described embodiments represent a technological solution to existing problems in the related-art concerning mistaken identification of fraudulent acts in the self-registration process.

In general, according to one embodiment, a self-service checkout apparatus includes a main body, a product scanner in the main body, a product placement area on a first side of the main body, a bagging area on a second side of the main body, a camera positioned to image user operations at the main body, and a control section. The control section is configured to: register merchandise items in a sales transaction based on commodity codes read by the product scanner; detect a registration movement of a customer based on images from the camera, the registration movement comprising appearing to move an object from the product placement area to the bagging area; identify a fraud act when the registration movement is detected but no merchandise item corresponding in time to the registration movement has been registered in the sales transaction; and output a notification of the fraud act only if at least one merchandise item has already been registered in the sales transaction when the fraud act is identified.

### Embodiment

An example embodiment will be explained. A self-service checkout apparatus according to this embodiment is a checkout apparatus (POS (Point of Sales) terminal) installed in a store such as a supermarket, a convenience store, or a mass retailer. The self-service checkout apparatus performs sales transaction processing of merchandise items to be sold in the store. With the self-service checkout apparatus, the customer himself or herself performs a merchandise registration operation and a payment operation. The merchandise registration operation involves passing a merchandise item in front of a scanner for the scanner to read a code symbol attached to the merchandise item. The payment operation involves ending the merchandise registration operation and then shifting to payment processing (for example, pressing of a payment key). When the customer performs the merchandise registration operation, the self-service checkout apparatus performs the corresponding merchandise registration processing. When the customer performs the payment operation, the self-service checkout apparatus performs the corresponding payment processing.

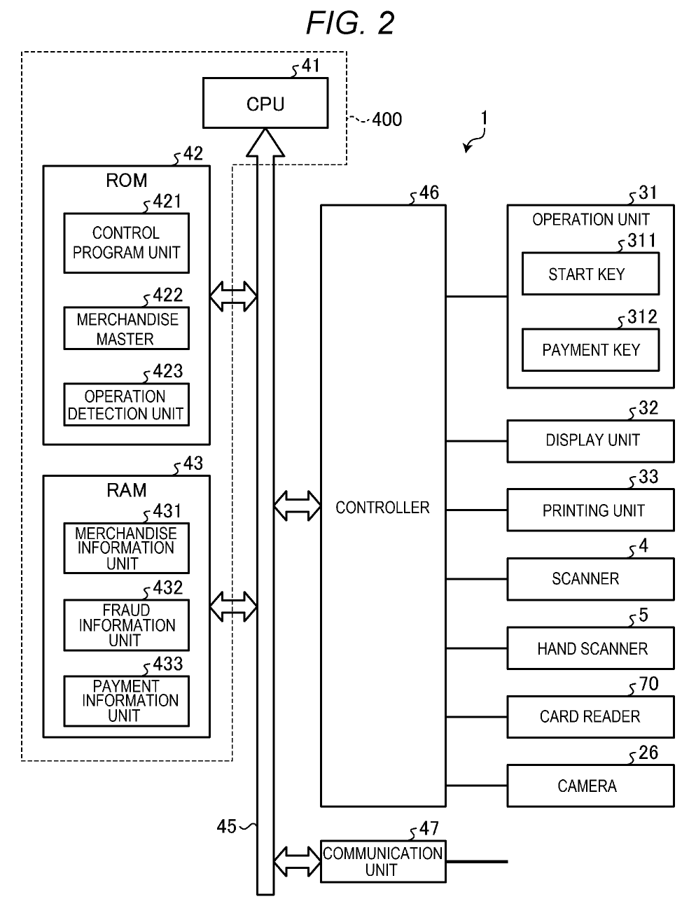

The merchandise registration processing refers to acquiring merchandise identification information (e.g., a merchandise code) related to a merchandise item based on the read code symbol, displaying a merchandise name and a price (i.e., merchandise information) of the merchandise item based on the acquired merchandise identification information on a display unit, and storing the merchandise information in a merchandise information unit 431 (see FIG. 2). The payment processing refers to displaying a total transaction amount (transaction total or amount due), settlement processing for a cash payment or payment with a medium such as a credit card, calculating and displaying the change back due based on a received amount in a cash settlement, instructing a change machine to give the change, dispensing a receipt on which the merchandise information and payment information (the total amount, the received amount, the change amount, etc.) are printed from a printing unit based on merchandise information stored in the merchandise information unit 431 in association with merchandise registration processing.

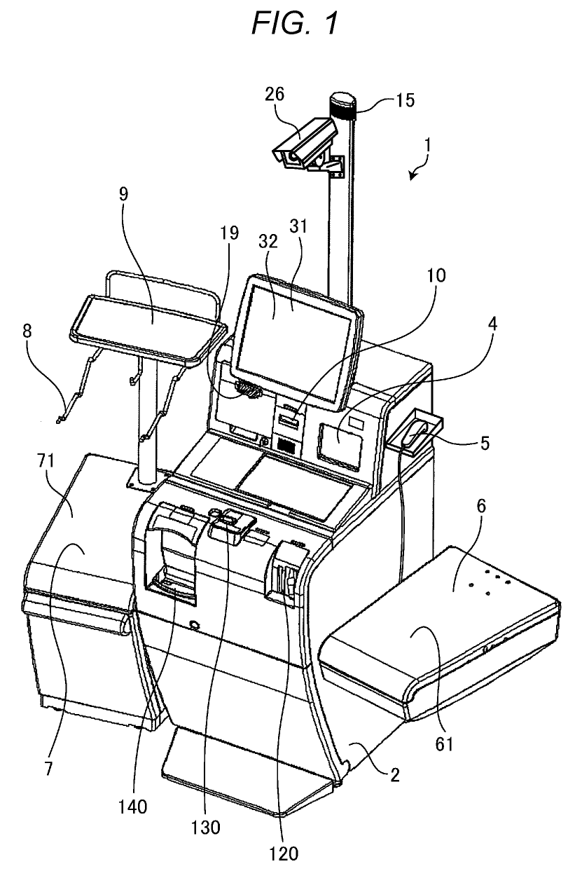

FIG. 1 is perspective view of a self-service checkout apparatus 1 according to the embodiment. The self-service checkout apparatus 1 has a main body 2, a placement table 6, and an attachment table 7 (bagging table). The main body 2 includes a power supply and a control section inside and a display unit 32, a scanner 4, and a hand scanner 5 in the upper part. The scanner 4 and the hand scanner 5 are devices that read a code symbol such as a barcode or a two-dimensional code attached to a merchandise item. The scanner 4 and the hand scanner 5 may work optically or by capturing images items. The self-service checkout apparatus 1 analyzes the code symbol and acquires merchandise identification information for identification of the merchandise item (e.g., a merchandise code). On the display unit 32, an operation unit 31 including various keys configured by a transparent touch panel is disposed.

As the display unit 32, e.g., a liquid crystal display is used. The display unit 32 displays a guidance window for explaining an operation method for the self-service checkout apparatus 1. The display unit 32 displays merchandise information and payment information for the merchandise items subjected to merchandise registration processing. The operation unit 31 can be or include a keyboard or keypad.

The main body 2 is provided with a card insertion hole 10 for insertion of a card such as a point card or a credit card of the customer at checkout. The credit card stores customer identification information and is inserted after card settlement is selected as the type of settlement. The main body 2 is provided with a receipt dispenser hole 19 from which a receipt is dispensed. Furthermore, the main body 2 is provided with a bill insertion and dispensing hole 120 for insertion of bills (cash) for settlement and dispensing bills for change. The main body 2 is also provided with a coin insertion hole 130 for insertion of coins for settlement, a coin ejection hole 140 ejecting coins for change, etc. On the back side of the main body 2, a pole extending upward is provided. In the upper part of the pole, a warning light 15 to be lighted if there is an abnormality or a fraud in the operation in the self-service checkout apparatus 1 or a store clerk is called. The abnormality or the fraud in the operation in the self-service checkout apparatus 1 is also displayed on the display unit 32. In the upper part of the pole immediately below the warning light 15, a camera 26 is attached. The camera 26 is directed downward and captures images from above of the movements associated with a registration operation performed by the customer.

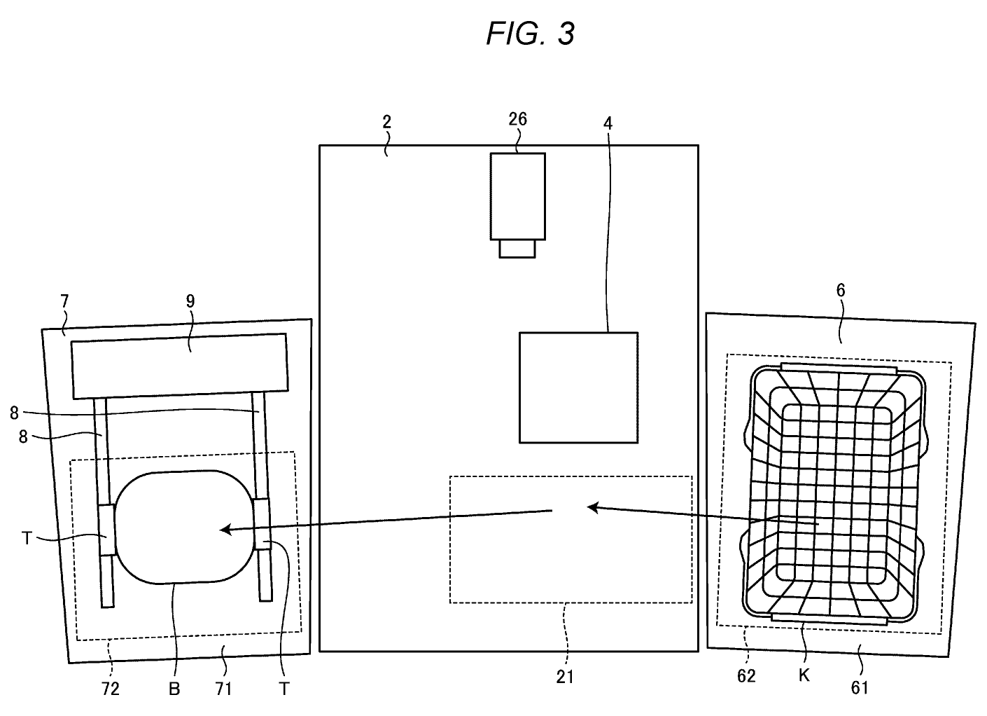

The placement table 6 for placement of a basket K (an example of an unregistered item container, see FIG. 3) holding merchandise items to be purchased by the customer and unpaid merchandise items (items before merchandise registration processing has been performed thereon) is attached to the main body 2. The basket K is an example of a container for a merchandise item to be purchased by the customer selected from merchandise items displayed within the store. Generally, the customer picks up the basket K when entering the store and puts merchandise items to purchase in the basket K during shopping. The placement table 6 is provided on upstream side of the flow of the merchandise items past the main body 2 (in the depiction, the right side of the main body 2). The placement table 6 has an upper surface 61 in a nearly flat rectangular shape. The basket K is placed on the upper surface 61.

The customer performs an operation (movements) of taking out one merchandise item from the basket K on the placement table 6 and passing the merchandise item in front of the scanner 4 so the scanner 4 can read the code symbol attached to the merchandise item (scanning operation and merchandise registration operation). Alternatively, the customer performs an operation of taking out a merchandise item from the basket K on the placement table 6 and holding the hand scanner 5 close to the merchandise item for the hand scanner 5 to read the code symbol attached to the merchandise item (merchandise registration operation). The self-service checkout apparatus 1 executes merchandise registration processing on the merchandise item based on a merchandise code acquired based on the code symbol read by the scanner 4 or the hand scanner 5.

The attachment table 7 is provided on the side opposite the placement table 6. The attachment table 7 is a table on which merchandise items that have been subjected to merchandise registration operation are to be placed. The attachment table 7 is a bagging table on which a bag B (see FIG. 3) can be set. The attachment table 7 has an upper surface 71 in a nearly flat rectangular shape. The attachment table 7 has a support extending upward from the back portion of the upper surface 71 and a temporary placement table 9 is attached to the upper portion of the support. The temporary placement table 9 is a table on which merchandise items may be temporarily placed during the bagging process.

From the temporary placement table 9, two supporting portions 8 having stick shapes extend frontward (toward the customer). The supporting portions 8 are substantially stick-shaped members on which a bag B (an example of a registered item container, see FIG. 3) for holding the merchandise items subjected to merchandise registration processing can be set (for example, handles T of the bag B (see FIG. 3) are hung for attachment from the supporting portions 8). From the temporary placement table 9, the pair of supporting portions 8 extend nearly in parallel. Accordingly, the bag B can be set on the supporting portions 8 with the entrance hole thereof open.

Here, the bag B is an example of a container in which a merchandise item subjected to merchandise registration processing can be put. The bag B may be a reuseable shopping bag or a reuseable basket brought by the customer to the store, a plastic bag brought to store by the customer, or a plastic bag purchased or provided as part of the transaction at the store.

The customer sets the bag B on the supporting portions 8 and puts the merchandise items subjected to the merchandise registration operation in the open bag B (performs bagging). The customer may temporarily place a fragile merchandise item that has been subjected to the merchandise registration operation on the temporary placement table 9 so such fragile item may be bagged last or the carefully. The series of actions/movements of taking out one merchandise item from the basket K on the placement table 6, operating the scanner 4 to read the item’s code symbol (scanning operation), and then a bagging operation of bagging the scanned merchandise item in the bag B is also collectively referred to as a registration operation.

The self-service checkout apparatus 1 includes an operation detection unit 423 (see FIG. 2) that detects whether the registration operation by the customer was performed. The operation detection unit 423 checks that each registration operation (i.e., of the actions taking out the merchandise item from the basket K on the placement table 6, the scanning operation with the scanner 4 to read the taken out merchandise item, and the bagging operation of bagging the scanned merchandise item in the bag B) is performed by analyzing the video or images (hereinafter, collectively referred to as "images") captured by the camera 26. Note that, in the present embodiment, the operation detection unit 423 is provided within a ROM 42, however, the operation detection unit 423 may be provided outside the ROM 42 in other examples. Alternatively, the operation detection unit 423 may be a device provided outside of the self-service checkout apparatus 1.

The self-service checkout apparatus 1 determines whether there is a fraud in the registration operation based on the registration operation detected by the operation detection unit 423 and whether a merchandise item is scanned (that is, whether the code symbol is read and merchandise registration processing is performed on the corresponding item) in the registration operation (strictly, the scanning operation). Specifically, if the operation detection unit 423 detects that the registration operation was performed by the customer, but the code symbol was not read (that is, the merchandise registration processing is not performed on an item), the self-service checkout apparatus 1 determines that a fraud (fraud event) may have been carried out by the customer. The reason that the code symbol attached to a merchandise item was not read may be an incorrect scanning operation by the customer or the customer may deliberately fail to perform the scanning operation. The detection of the registration operation by the operation detection unit 423 will be described with reference to FIG. 3.

After the merchandise registration processing for all merchandise items is finished and all merchandise items are put in the bag B, the customer performs a payment operation by operating a payment key 312 (see FIG. 2). If the payment key 312 is operated, the self-service checkout apparatus 1 executes payment processing for the transaction based on the merchandise information stored in the merchandise information unit 431.

Here, a hardware configuration of the self-service checkout apparatus 1 is explained. FIG. 2 is a block diagram showing the hardware configuration of the self-service checkout apparatus 1. As shown in FIG. 2, the self-service checkout apparatus 1 includes a CPU (Central Processing Unit) 41 as an example of a microprocessor, the ROM (Read Only Memory) 42, a RAM (Random Access Memory) 43, etc. The CPU 41 serves as a main control part of the self-service checkout apparatus 1. The ROM 42 stores various programs. Note that, in place of the ROM 42, an HDD or an SSD may be provided. The RAM 43 loads programs and various kinds of data. The CPU 41, the ROM 42, and the RAM 43 are connected to one another via a bus 45. The CPU 41, the ROM 42, and the RAM 43 forms a control section 400. That is, the control section 400 executes control processing of the self-service checkout apparatus 1 by the CPU 41 operating according to a control program stored in the ROM 42 and loaded in the RAM 43.

The ROM 42 has a control program unit 421, a merchandise master 422, and the operation detection unit 423. The control program unit 421 stores the control program for operating the self-service checkout apparatus 1. The merchandise master 422 stores merchandise information about the respective merchandise items for sale at the store in correlation with merchandise codes for identification of the merchandise items.

The operation detection unit 423 detects the registration operation(s) by the customer. Specifically, the operation detection unit 423 detects the taking out a merchandise item from the basket K placed on the placement table 6 using the images captured by the camera 26. The operation detection unit 423 also detects the operation (use) of the scanner 4 to read the code symbol (the scanning operation) based on images captured by the camera 26. The operation detection unit 423 further detects the bagging operation (the bagging) of the scanned merchandise item into the bag B using images captured by the camera 26.

Here, the detection of the registration operation by the customer performed by the operation detection unit 423 is explained using FIG. 3. FIG. 3 is a diagram for explanation of the detection of the registration operation by the operation detection unit 423 of the self-service checkout apparatus 1. FIG. 3 shows the main body 2, the placement table 6, and the attachment table 7 from above. Note that aspects not relevant to the explanation of the detection of the registration operation are omitted from FIG. 3. As shown in FIG. 3, the camera 26 can capture all areas related to the placement table 6, the main body 2, and the attachment table 7.

First, the operation detection unit 423 detects that a merchandise item is taken out from an area 62 in which the basket K on the placement table 6 is placed. Strictly speaking, the operation detection unit 423 detects when any article is taken out because whether a removed article is store merchandise or not is not necessarily detectable at this point. However, in the following description, a removed item of merchandise or any other article type in this context will be collectively referred to as a merchandise item. For example, when the camera 26 captures an image in which a human hand enters the area 62 and picks up (holds) a merchandise item and removes the item from area 62, the operation detection unit 423 detects that the merchandise item was taken out. Note that, if a human hand holding something passes through the area 62 without any merchandise item being recognized as being taken out from the basket K, the operation detection unit 423 may still detect (identify) that a merchandise item was taken out.

After detecting that a merchandise item is taken out, if the merchandise item moves in the direction of the scanner 4 and passes through an area 21 located in front of the scanner 4, the operation detection unit 423 detects that the scanning operation is performed.

If the merchandise item after the scanning operation moves to an area 72 (indicating the position where the bag B is set on the attachment table 7) the operation detection unit 423 detects a bagging of the merchandise item.

As described above, if the merchandise item located in the area 62 moves to the area 21 and then moves to the area 72, the operation detection unit 423 detects that a registration operation on the merchandise item was performed based on the images captured by the camera 26. Then, if the code symbol was not read by the scanner 4 in correspondence with the movement of the merchandise item (that is, the merchandise registration processing on the merchandise item was not performed), the self-service checkout apparatus 1 determines that there is a fraud. Accordingly, when a customer removes a reusable shopping bag (bag B) from the basket K then sets it on the attachment table 7, the scanner 4 will not read a code symbol because no code symbol is attached to the bag B (it is not store merchandise). As such, the customer’s movements for removing the reusable shopping bag (bag B) from the basket K to be set on the attachment table 7 may be mistakenly determined as a fraud because no code symbol was read. If the bag B is taken out from a pocket but temporarily set in, then moved from, the area 62 through the area 21 to the area 72, the movements may similarly be mistakenly determined as a fraud.

Returning to FIG. 2, the RAM 43 has the merchandise information unit 431, a fraud information unit 432, and a payment information unit 433. The merchandise information unit 431 stores merchandise information (merchandise name, merchandise price, etc.) of the merchandise items that have been subjected to merchandise registration processing. The merchandise information is acquired from the merchandise master 422 based on the acquired merchandise code. The fraud information unit 432 stores fraud information if the self-service checkout apparatus 1 determines as a fraud event occurred. For example, the fraud information is a time of the fraud determination, image information captured by the camera 26 around the fraud time, and the like. The payment information unit 433 stores merchandise information related to the merchandise items subjected to the payment processing in the transaction.

The control section 400 is connected to the operation unit 31, the display unit 32, a printing unit 33, the scanner 4, the hand scanner 5, a card reader 70, and the camera 26 via the bus 45 and/or a controller 46. The operation unit 31 may be a touch panel provided on the display unit 32. The controller 46 is, for example, an input/output (I/O) interface, a peripheral device interface, a peripheral device controller, device hub, or the like.

The operation unit 31 has a start key 311 and the payment key 312. The start key 311 is a key operated by the customer when beginning the merchandise registration operation. Once the start key 311 is operated (e.g., pressed), merchandise registration operation is enabled with respect to the merchandise item(s) held in the basket K on the placement table 6. The payment key 312 is a key operated when payment processing of the merchandise item(s) subjected to the merchandise registration processing is to be performed. After the payment key 312 is operated (e.g., pressed), payment processing for the merchandise items subjected to the merchandise registration processing is enabled.

The display unit 32 displays images of various keys to be operated by the customer, merchandise information of merchandise items subjected to the merchandise registration processing, payment information subjected to the payment processing, etc. The printing unit 33 dispenses a receipt on which the merchandise information, the payment information, etc. are printed from the receipt dispenser hole 19. The scanner 4 and the hand scanner 5 read the code symbols attached to the merchandise items. The card reader 70 magnetically or otherwise reads information from various cards inserted from the card insertion hole 10. The camera 26 is attached to the pole and captures images of the registration operation by the customer from above.

Further, the control section 400 is connected to a communication unit 47 via the bus 45. The communication unit 47 is electrically connected to another self-service checkout apparatus 1, a store server, or the like via a communication line and mutually transmits and receives information.

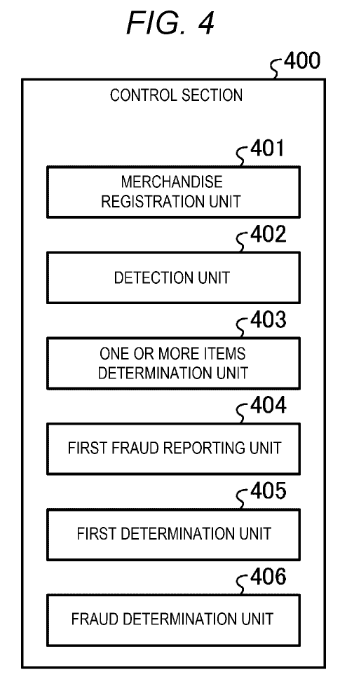

Here, the functional aspects of the self-service checkout apparatus 1 according to the present embodiment are explained. FIG. 4 is a functional block diagram showing the functional configurations of the self-service checkout apparatus 1 according to the embodiment. The control section 400 functions as a merchandise registration unit 401, a detection unit 402, a one or more items determination unit 403, a first fraud reporting unit 404, a first determination unit 405, and a fraud determination unit 406. Such units are configurational aspects established according to the control program stored in the control program unit 421 of the ROM 42.

The merchandise registration unit 401 performs merchandise registration processing. Specifically, the merchandise registration unit 401 executes the merchandise registration processing on a merchandise item by reading the code symbol of the merchandise item during the scanning operation (merchandise registration operation) performed by the customer.

The detection unit 402 detects whether the registration operation is performed. Specifically, the detection unit 402 (operation detection unit 423) detects a registration operation performed by the customer based on the images captured by the camera 26.

The one or more items determination unit 403 determines whether one or more merchandise items have been subjected to merchandise registration processing. Specifically, the one or more items determination unit 403 checks whether one or more merchandise items have been subjected to merchandise registration processing based on whether merchandise information of merchandise items subjected to merchandise registration processing is stored in the merchandise information unit 431. If merchandise information is stored in the merchandise information unit 431, the one or more items determination unit 403 determines that at least one merchandise item has been subjected to merchandise registration processing. If no merchandise information is stored in the merchandise information unit 431, the one or more items determination unit 403 determines that no merchandise items have been subjected to merchandise registration processing.

If the merchandise registration processing has been performed on one or more merchandise items, the first fraud reporting unit 404 may report a fraud in the registration operation but if no merchandise items have been registered yet (that is, if the merchandise registration processing is not yet performed on even a single merchandise item) the first fraud reporting unit does not report fraud events even if detected. Specifically, if the one or more items determination unit 403 determines that one or more merchandise items have been subjected to merchandise registration processing, the first fraud reporting unit 404 may report a detected fraud in the registration operation of bagging a merchandise item, but if no item has been registered at all yet, the first fraud reporting unit 404 does not report a detected fraud in the registration operation (even if such was nominally detected).

For example, the report of a detected fraud may be display of a message indicating that a fraud may have been carried out (e.g., a message "please scan the merchandise item again" or the like) on the display unit 32. Alternatively, or further, the warning light 15 may be lit (or blinked) to indicate that a fraud may have been carried out.

The first determination unit 405 determines whether there is a merchandise item within a first container (e.g., basket K) on the placement table 6. Specifically, the first determination unit 405 checks whether there is a merchandise item within the basket K placed on the placement table 6 based on the images captured by the camera 26.

If merchandise registration processing is performed on one or more merchandise items and the first determination unit 405 determines that there is still a merchandise item within the basket K, the first fraud reporting unit 404 reports a fraud and, if the merchandise registration processing is performed on one or more merchandise items, but the first determination unit 405 determines that the basket K is empty (there is no merchandise item), the first fraud reporting unit 404 does not report a fraud.

The fraud determination unit 406 determines whether there is a fraud based on the detection of the registration operation by the detection unit 402 in the images captured by the camera 26 and whether merchandise registration processing is performed on a merchandise item by the merchandise registration unit 401. If the detection unit 402 detects that the registration operation was performed (based on the images captured by the camera 26) and the merchandise registration unit 401 reads a code symbol ( and a merchandise registration processing is performed based thereon), the fraud determination unit 406 determines that there is no fraud (no fraud was carried out). If the detection unit 402 detects that the registration operation is performed (based on the images captured by the camera 26) but the merchandise registration unit 401 does not perform a merchandise registration processing on a merchandise item, the fraud determination unit 406 determines that there is a fraud (a fraud was carried out).

If the fraud determination unit 406 determines that there is a fraud and merchandise registration processing has been performed on one or more merchandise items, the first fraud reporting unit 404 reports the fraud but does not report the fraud if no item has been registered yet. Specifically, if the fraud determination unit 406 determines that there is a fraud and the merchandise registration processing was already performed on one or more merchandise items, the first fraud reporting unit 404 reports the fraud but if the one or more items determination unit 403 determines that merchandise registration processing has not been performed on any merchandise items yet, the detected (determined) fraud is not reported.

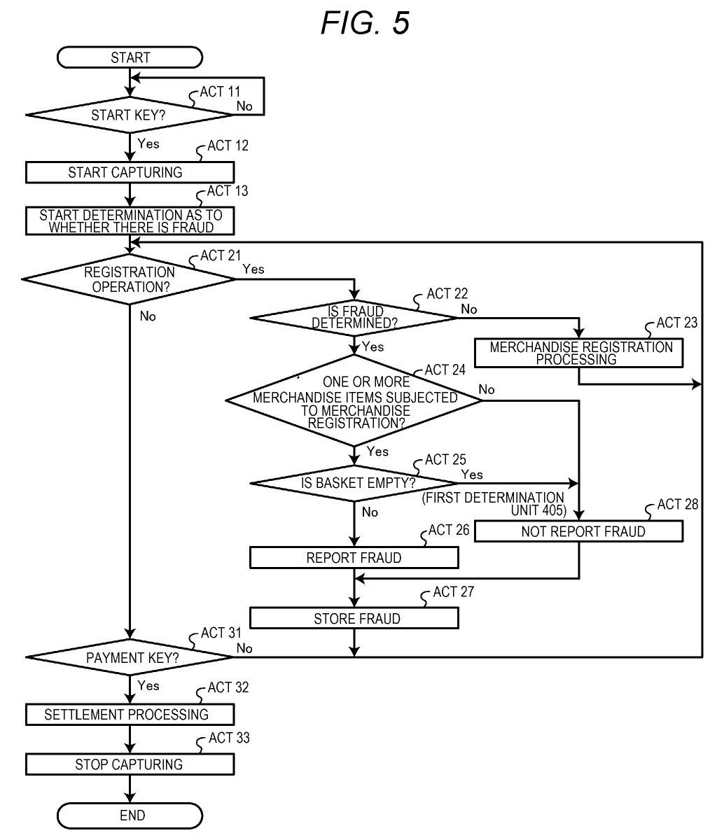

FIG. 5 is a flowchart of the control processing of the self-service checkout apparatus 1. As shown in FIG. 5, the control section 400 of the self-service checkout apparatus 1 checks whether the start key 311 has been operated (ACT11). The control section 400 stands by (No in ACT11) until the start key 311 is operated (Yes in ACT11). After the start key 311 is operated, the control section 400 starts image capturing by the camera 26 (ACT12). Then, the control section 400 begins a determination process as to whether there is a fraud based on detection of registration operations by the operation detection unit 423 (ACT13).

The detection unit 402 checks whether the operation detection unit 423 detects a registration operation (the registration operation has been performed by the customer) (ACT21). If the registration operation is detected (Yes in ACT21), the fraud determination unit 406 checks whether there is a fraud based on whether merchandise registration processing was performed (ACT22). If the fraud determination unit determines that there is no fraud (no fraud is carried out)(No in ACT22), the merchandise registration unit 401 executes the merchandise registration processing (ACT23) on a merchandise item based on the merchandise code acquired from the code symbol read by the scanner 4. The merchandise registration processing executed in ACT23 includes processing of storing merchandise information in the merchandise information unit 431. After the merchandise registration processing in ACT23, the control section 400 returns to ACT21.

Alternatively, if there is a fraud (a fraud is carried out)(Yes in ACT22), the one or more items determination unit 403 checks whether any merchandise items have already been subjected to merchandise registration by checking whether merchandise information is stored in the merchandise information unit 431 (ACT24). If the one or more items determination unit 403 determines that at least one merchandise item has been subjected to merchandise registration (Yes in ACT24), the first determination unit 405 next determines whether the basket K (placed on the placement table 6) is empty based on the images captured by the camera 26 (ACT25). If the basket K is not empty (No in ACT25), the first fraud reporting unit 404 now reports the fraud identified in ACT22 (ACT26). Then, the control section 400 stores fraud information indicating that a fraud was carried out in the fraud information unit 432 (ACT27). Then, the control section 400 returns to ACT21.

Alternatively, if the one or more items determination unit determines no merchandise items have been subjected to merchandise registration (No in ACT24), the first fraud reporting unit 404 does not report the fraud identified in ACT22 (ACT28). That is, the processing in ACT 28 executed by the first fraud reporting unit 404 is to not perform (that is, skip) the processing of ACT26. Specifically, the first fraud reporting unit 404 does not display a message on the display unit 32 indicating that a fraud may have been carried out and/or does not light or blink the warning light 15. The control section 400 executes processing in ACT27. That is, when the one or more items determination unit 403 determines no items have yet been subjected to merchandise registration (No in ACT24), the first fraud reporting unit 404 does not execute the processing in ACT26, but executes the processing in ACT27. Through this processing, a fraud report based on a false determination that identifies a setting of a bag B on the attachment table 7 before the start of the merchandise registration processing as a fraud event can be prevented. Similarly, a fraud report based detecting of a removing of a purse or the like from the basket K to the set a bag B before the start of the merchandise registration processing can be prevented.

In ACT25, if the first determination unit determines that the basket K is empty (Yes in ACT25), the first fraud reporting unit 404 also does not report the fraud identified in ACT22. That is, the processing of ACT28 is executed by the first fraud reporting unit 404 so as to not perform the processing in ACT26. The control section 400 then executes the processing in ACT27. That is, if the basket K is empty (Yes in ACT25), the first fraud reporting unit 404 skips the processing in ACT26, but executes the processing in ACT27. Through this processing, a fraud report based on a likely false determination related to removing of a final, non-merchandise item from basket K after the execution of the merchandise registration processing on all merchandise items being purchased can be prevented. For example, removal of ancillary, non-merchandise items (e.g., spoons, forks, and chopsticks) from the basket K and placing such non-merchandise items in the bag B can be prevented from being treated as a fraud operation.

If the operation detection unit 423 does not detect a registration operation (No in ACT21), the control section 400 checks whether the payment key 312 is operated (ACT31). If the payment key 312 is not operated (No in ACT31), the control section 400 returns to ACT21 but if the payment key 312 is operated (Yes in ACT31), the control section 400 executes settlement processing related to the transaction based on the merchandise information stored in the merchandise information unit 431 (ACT32). The control section 400 then stops (ends) the image capturing by the camera 26 (ACT33). Finally, the control section 400 ends the processing and may return to ACT11.

According to the embodiment, if a fraud is detected when a registration-type operation is performed by the customer and at least one merchandise item has already been subjected to merchandise registration processing, a message indicating a fraud related to bagging without merchandise registration processing is delivered but if no merchandise items have been subjected to merchandise registration processing yet, the message is not delivered. Accordingly, a mistaken fraud report can be prevented.

Further, in the present embodiment, even when a fraud is detected when a registration-type operation is performed by the customer, if merchandise registration processing has already been performed on at least one merchandise item and the basket K is now empty, a message indicating a fraud of bagging without merchandise registration processing is not delivered. Accordingly, a mistaken fraud report can be prevented.

### (First Modified Example)

Here, a first modified example of the first embodiment is explained. In the first embodiment, even when a fraud related to the registration operation by the customer is detected (determined), if merchandise registration processing has not been performed on any merchandise items, the fraud is not reported. In the first modified example, when a registration-type operation is performed by the customer, if merchandise registration processing has not yet been performed on any merchandise items, there is no attempt to detect a fraud event. Accordingly, a fraud event will not be reported.

In the first modified example, if the one or more items determination unit 403 determines that merchandise registration processing has not been performed any merchandise items, the fraud determination unit 406 makes no determination at all regarding fraud event, thus, the first fraud reporting unit 404 will not report a fraud because none was identified by the fraud determination unit 405.

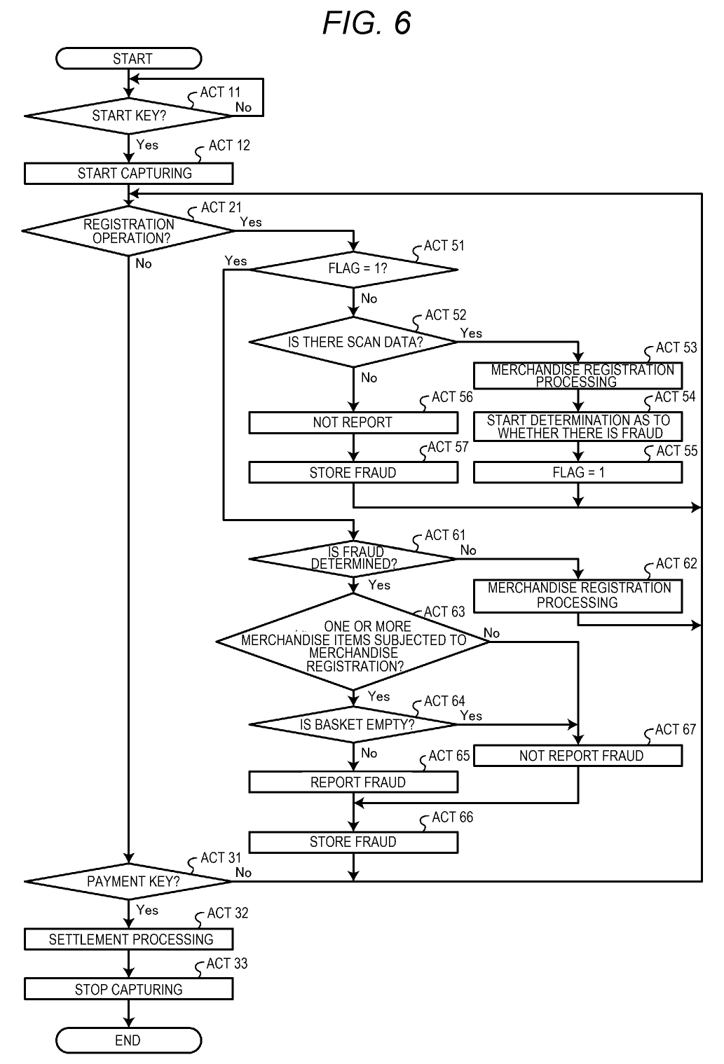

FIG. 6 is a flowchart of control in the first modified example. Note that, in FIG. 6, the same reference symbols are assigned as in FIG. 5 when the processing is substantially similar thereto, and further explanation thereof may be omitted or simplified.

If the detection unit 402 determines that the operation detection unit 423 detects the registration operation in ACT21 (Yes in ACT21), the one or more items determination unit 403 checks whether an associated flag value is "1" (ACT51). The setting of the flag concerns ACT55. If the flag is not "1" (No in ACT51), the control section 400 checks whether a code symbol on a merchandise item is read (ACT52). If a code symbol is read (Yes in ACT52), the merchandise registration unit 401 executes merchandise registration processing related to the merchandise item (ACT53). Then, the control section 400 starts a determination process (executed by the fraud determination unit 406) (ACT54) as to whether there is a fraud in the registration operation based on the detection of a registration operation by the operation detection unit 423 using the images captured by the camera 26. Then, the control section 400 stores the flag "1" indicating that merchandise registration processing has been performed on at least one merchandise item in the RAM 43 (ACT55). That is, the determination in ACT51 is a determination by the one or more items determination unit 403 as to whether one or more merchandise items have been subjected to merchandise registration processing, if the one or more items determination unit 403 determines that the flag is "1", the one or more items determination unit 403 determines that one or more merchandise items have been subjected to merchandise registration processing, and, if the one or more items determination unit 403 determines that the flag is not "1", the one or more items determination unit determines that one or more merchandise items have not been subjected to merchandise registration processing. Then, the control section 400 returns to ACT21.

If flag is not “1” and the control section 400 determines that a code symbol is not read from a merchandise item (No in ACT52), the first fraud reporting unit 404 does not report a fraud (ACT56). Then, the control section 400 stores fraud information in the fraud information unit 432 (ACT57). Then, the control section 400 returns to ACT21.

If the flag is "1" (Yes in ACT51), the fraud determination unit 406 checks whether there is a fraud based on the registration operation detected by the operation detection unit 423 and whether merchandise registration processing is performed (ACT61). If the fraud determination unit 406 determines that there is no fraud (no fraud is carried out) (No in ACT61), the merchandise registration unit 401 executes the merchandise registration processing on the merchandise item based on the merchandise code acquired by analyzing the code symbol read by the scanner 4 (ACT62). Then, the control section 400 returns to ACT21.

Alternatively, if the fraud determination unit determines that there is a fraud (a fraud is carried out) (Yes in ACT61), then, the one or more items determination unit 403 checks whether one or more merchandise items have been subjected to merchandise registration processing (ACT63). If t one or more merchandise items have been subjected to merchandise registration processing (Yes in ACT63), then, the first determination unit 405 checks whether the basket K is empty based on the images captured by the camera 26 (ACT64). If the basket K is not empty (No in ACT64), the first fraud reporting unit 404 reports the fraud identified in ACT61 (ACT65). Then, the control section 400 stores fraud information indicating that a fraud was carried out in the fraud information unit 432 (ACT66). Then, the control section 400 returns to ACT21.

Alternatively, if no merchandise items have been subjected to merchandise registration processing (No in ACT63) and the basket K is empty (Yes in ACT64), the first fraud reporting unit 404 does not report the fraud determined in ACT61 (ACT67). That is, the first fraud reporting unit 404 does not perform the processing of ACT65. Specifically, the first fraud reporting unit 404 does not display a message indicating that a fraud may have been carried out on the display unit 32 or the processing of lighting or blinking the warning light 15. The control section 400 then executes processing in ACT66. That is, if at least one merchandise item has not been subjected to merchandise registration processing (No in ACT63) and the basket K is empty (Yes in ACT64), the first fraud reporting unit 404 does not execute the processing in ACT65, but does execute the processing in ACT66. Through the processing, a fraud report based on a likely false determination related to the operation of setting the bag B on the attachment table 7 before the start of the merchandise registration processing can be prevented. Similarly, a fraud report based on a false determination that the operation of moving a purse or the like from the basket K to the set bag B before the start of the merchandise registration processing can be prevented.

According to the first modified example, when the registration operation is detected, if no merchandise items have been subjected to merchandise registration processing, whether there is a fraud is not checked. Accordingly, a fraud is not reported. Alternatively, if merchandise registration processing has been performed at least one merchandise item, whether there is a fraud is checked and a message indicating that a fraud of bagging without merchandise registration processing can be delivered.

### (Second Modified Example)

Here, a second modified example is explained. In previous examples, if no merchandise items have been subjected to merchandise registration processing yet, a fraud is not reported even if detected. In the second modified example, if there is no merchandise item within an unregistered item container (e.g., basket K) or if there is no merchandise item within a registered item container (e.g., bag B), a detected fraud is not reported. The camera 26 can generally capture images of the inside of the unregistered item container and the registered item container, and the control section 400 checks whether there is a merchandise item within the unregistered item container and whether there is a merchandise item within the registered item container based on images captured by the camera 26. Note that, in previous examples, the bag B is shown attached to the attachment table 7, however, in the second modified example, the registered item container may be something else, such as a basket or the registered item may merely be put on the attachment table 7.

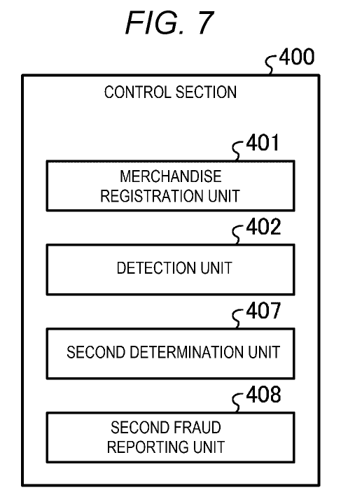

FIG. 7 is a functional block diagram of a self-service checkout apparatus 1 according to the second modified example. The control section 400 functions as a merchandise registration unit 401, a detection unit 402, a second determination unit 407, and a second fraud reporting unit 408 according to the control program stored in the control program unit 421 of the ROM 42.

The merchandise registration unit 401 and the detection unit 402 have the same functions as those already described.

The second determination unit 407 checks whether the unregistered item container (e.g., a basket K) on the placement table 6 is empty and also if the registered item container on the attachment table 7 is empty. Specifically, the second determination unit 407 checks whether the unregistered item container (e.g., the basket K) placed on the placement table 6 is empty based on whether there is any item (including ancillary equipment for the merchandise items, e.g., spoons, and forks) within the unregistered item container, and also checks whether the registered item container (e.g., the bag B) is empty based on whether there is any merchandise item within the registered item container. If an item appears within the unregistered item container in an image captured by the camera 26, the second determination unit 407 determines that the unregistered item container is not empty. If no item appears within the unregistered item container in an image captured by the camera 26, the second determination unit 407 determines that the unregistered item container is empty. The second determination unit 407 checks whether the registered item container is empty based on whether there is an item within the registered item container in the images captured by the camera 26. If a merchandise item appears within the unregistered item container, the second determination unit 407 determines that the registered item container is not empty. If no merchandise item appears within the registered item container, the second determination unit 407 determines that the registered item container is empty.

If the second determination unit 407 determines that there are merchandise items within the unregistered item container and the registered item container, the second fraud reporting unit 408 reports a fraud with respect to a merchandise item bagged without merchandise registration processing and does not report a fraud with respect to a merchandise item bagged without merchandise registration if the second determination unit determines that there are no merchandise item within the unregistered item container or the registered item container.

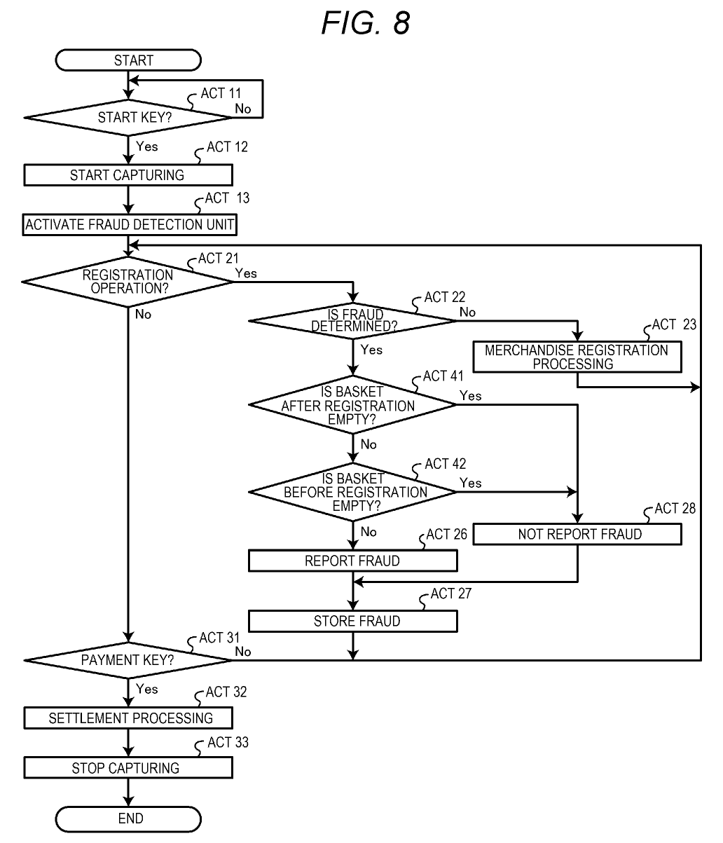

FIG. 8 is a flowchart of the second modified example. Note that, in FIG. 8, the same reference symbols are assigned to the control processing already described.

In FIG. 8, if the first fraud determination unit 405 determines that there is a fraud (a fraud is carried out)(Yes in ACT22), the second determination unit 407 checks whether the container on the attachment table 7 is empty (ACT41). If the second determination unit determines that the container (post-registration basket) on the attachment table 7 is not empty (No in ACT41), the second determination unit 407 checks whether the basket K (pre-registration basket) is empty based on the images captured by the camera 26 (ACT42). If the basket K is not empty (No in ACT42), the second fraud reporting unit 408 reports the fraud determined in ACT22 (ACT26). Then, the control section 400 stores fraud information indicating that a fraud was carried out in the fraud information unit 432 (ACT27). Then, the control section 400 returns to ACT21.

Alternatively, if the second determination unit 407 determines that the container placed on the attachment table 7 is empty (Yes in ACT41), the second fraud reporting unit 408 does not report the fraud determined in ACT 22 (ACT28). That is, the second fraud reporting unit 408 skips processing in ACT26. Specifically, the second fraud reporting unit 408 does not display a message on the display unit 32 indicating that a fraud may have been carried out or does not light or blink the warning light 15. Then, the control section 400 executes processing in ACT27. That is, if the second determination unit 407 determines that the container placed on the attachment table 7 is empty (Yes in ACT41), the second fraud reporting unit 408 does not execute the processing in ACT26, but does execute the processing in ACT27. Through the processing, a fraud report based on a false determination related to moving a purse or the like from the basket K to the attachment table 7 before the start of the merchandise registration processing can be prevented.

Alternatively, if the second determination unit 407 determines that the basket K is empty (Yes in ACT42), the second fraud reporting unit 408 does not report the fraud determined in ACT22 (ACT28). That is, the second fraud reporting unit 408 does not perform processing in ACT26. Specifically, the second fraud reporting unit 408 does not display a message on the display unit 32 indicating that a fraud may have been carried out or perform processing of lighting or blinking the warning light 15. Then, the control section 400 executes processing in ACT27. That is, if the second determination unit 407 determines that the basket K is empty (Yes in ACT42), the second fraud reporting unit 408 does not execute the processing in ACT26, but executes the processing in ACT27. Through the processing, after merchandise registration processing has been executed with respect to all merchandise items (when no merchandise item to be purchased is left), a fraud report based on the false determination related to moving ancillary items (e.g., spoons, forks, and chopsticks) related to the purchased merchandise items from the basket K to the bag B (or other registered item container) can be prevented.

According to the second modified example, when the registration operation is detected, if there are merchandise items in both the basket K and the container on the attachment table 7, a message indicating that a fraud of bagging without merchandise registration processing is delivered. Alternatively, if there are no merchandise items in the basket K or the container placed on the attachment table 7, a message indicating that a fraud of bagging without merchandise registration processing is not delivered. Therefore, a mistaken fraud report can be prevented.

While the above specific examples have been presented by way of explanation only and are not intended to limit the scope of the present disclosure. Indeed, the novel embodiments, may be embodied in a variety of other forms; furthermore, various omissions, substitutions and changes in the form may be made without departing from the spirit of the disclosure.

In an embodiment, the basket K is an example of an unregistered item container. However, in other examples, a shopping cart may be employed as another example of the unregistered item container.

In an embodiment, a bag B is an example of a registered item container, the registered item container may be a basket placed on the attachment table 7.

A program executed in the self-service checkout apparatus 1 may be recorded as a file in an installable format or executable format in a computer-readable recording medium such as a CD-ROM, a flexible disk (FD), a CD-R, a DVD (Digital Versatile Disk).

A program executed in the self-service checkout apparatus 1 may be stored in a computer connected to a network such as the Internet, downloaded via a network or distributed via a network such as the Internet.

A program executed in the self-service checkout apparatus 1 may be incorporated in a ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Additionally, the embodiments described above can be combined mutually.

What is claimed is:

1. A self-service checkout apparatus, comprising:
a main body;
a product scanner in the main body;
a product placement area on a first side of the main body;
a bagging area on a second side of the main body;
a camera positioned to image user operations at the main body; and
a control section configured to:
register merchandise items in a sales transaction based on commodity codes read by the product scanner;
detect a registration movement of a customer based on images from the camera, the registration movement comprising appearing to move an object from the product placement area to the bagging area;
identify a fraud act when the registration movement is detected but no merchandise item corresponding in time to the registration movement has been registered in the sales transaction; and
output a notification of the fraud act only if at least one merchandise item has already been registered in the sales transaction when the fraud act is identified.

2. The self-service checkout apparatus according to claim 1, further comprising:
a display screen on the main body, wherein
the notification is output to the display screen.

3. The self-service checkout apparatus according to claim 1, further comprising:
a display screen, wherein
the notification is output to the display screen.

4. The self-service checkout apparatus according to claim 1, further comprising:
a pole mounted to the main body; and
a light mounted on the pole, wherein
the notification causes the light to blink or change color.

5. The self-service checkout apparatus according to claim 1, wherein the registration movement further comprises appearing to use the product scanner on the object.

6. The self-service checkout apparatus according to claim 1, further comprising:
a handheld scanner mounted on the main body, wherein
the registration movement further comprises appearing to use the handheld scanner on the object.

7. The self-service checkout apparatus according to claim 1, wherein
the product placement area is a table surface or platform attached to main body, and
the table surface or platform is sized for a shopping basket.

8. The self-service checkout apparatus according to claim 7, wherein
the control section is further configured to:
identify whether a shopping basket in the product placement area is empty based on images from the camera, and
the notification of the fraud act is not output when the shopping basket is identified as empty directly after the detected registration movement.

9. The self-service checkout apparatus according to claim 1, wherein
the control section is further configured to:
identify whether the product placement area is empty based on images from the camera, and
the notification of the fraud act is not output when the product placement area is identified as empty directly after the detected registration movement.

10. The self-service checkout apparatus according to claim 1, wherein
the control section is further configured to:
identify whether a shopping basket in the product placement area is empty based on images from the camera, and
the notification of the fraud act is not output when the shopping basket is identified as empty directly after the detected registration movement.

11. A self-service checkout apparatus, comprising:
a main body;
a product scanner in the main body;
a product placement area on a first side of the main body;
a bagging area on a second side of the main body;
a camera positioned to image user operations at the main body; and
a control section configured to:
register merchandise items in a sales transaction based on commodity codes read by the product scanner;
detect a registration movement of a customer based on images from the camera, the registration movement comprising appearing to move an object from the product placement area to the bagging area;
identify a fraud act when the registration movement is detected but no merchandise item corresponding in time to the registration movement has been registered in the sales transaction;
identify whether the product placement area is empty based on images from the camera; and
output a notification of the fraud act only if the product placement area is not identified as empty directly after the fraud act is identified.

12. The self-service checkout apparatus according to claim 11, further comprising:
a display screen on the main body, wherein
the notification is output to the display screen.

13. The self-service checkout apparatus according to claim 11, further comprising:
a display screen, wherein
the notification is output to the display screen.

14. The self-service checkout apparatus according to claim 11, further comprising:
a pole mounted to the main body; and
a light mounted on the pole, wherein
the notification causes the light to blink or change color.

15. The self-service checkout apparatus according to claim 11, wherein the registration movement further comprises appearing to use the product scanner on the object.

16. The self-service checkout apparatus according to claim 11, further comprising:
a handheld scanner mounted on the main body, wherein
the registration movement further comprises appearing to use the handheld scanner on the object.

17. The self-service checkout apparatus according to claim 11, wherein the product placement area is a shopping basket on a table surface or platform attached to main body.

18. The self-service checkout apparatus according to claim 11, wherein the control section is further configured to output the notification of the fraud act only when at least one merchandise item has already been registered in the sales transaction when the fraud act is identified.

19. A control method for fraud monitoring at a self-service checkout apparatus, the control method comprising:
registering merchandise items in a sales transaction based on commodity codes read by a product scanner of a self-service checkout apparatus;
detecting a registration movement of a customer based on images from a camera positioned to image user operations at the self-service checkout apparatus, the registration movement comprising appearing to move an object from a product placement area on one side of the self-service checkout apparatus to a bagging area on the opposite side of the self-service checkout apparatus;
identifying a fraud act when the registration movement is detected but no merchandise item corresponding in time to the registration movement has been registered in the sales transaction; and
outputting a notification of the fraud act only if at least one merchandise item has already been registered in the sales transaction when the fraud act is identified.

20. The control method according to claim 19, further comprising:
identifying whether the product placement area is empty based on images from the camera; and
outputting the notification of the fraud act when the product placement area is not identified as empty directly after the fraud act is identified.
